(19) United States
(12) Patent Application Publication
(10) Pub. No.: US 2026/0024195 A1
(43) Pub. Date: Jan. 22, 2026

(54) SYSTEM AND METHOD FOR PROCESSING ULTRASOUND IMAGES

(71) Applicant: CANON MEDICAL SYSTEMS CORPORATION, Otawara-shi (JP)

(72) Inventors: Steven Alexander REYNOLDS, Edinburgh (GB); Morvyn MYLES, Edinburgh (GB); Magnus WAHRENBERG, Edinburgh (GB)

(73) Assignee: CANON MEDICAL SYSTEMS CORPORATION, Otawara-shi (JP)

(21) Appl. No.: 18/775,901

(22) Filed: Jul. 17, 2024

(51) Int. Cl. G06T 7/00; G06N 20/00; G06T 7/10

(52) U.S. Cl. CPC G06T 7/0012; G06N 20/00; G06T 7/10; G06T 2207/10136

(57) ABSTRACT

A method for processing ultrasound imaging data comprising: obtaining a two-dimensional ultrasound image; deriving from input data, classification information for each of a plurality of features in the two-dimensional ultrasound image, the input data comprising at least one of: the two-dimensional ultrasound image or three-dimensional ultrasound data corresponding to the two-dimensional image; deriving a rendered image by supplying to an image transformation machine learning model: the two-dimensional ultrasound image as an input image; and the classification information for each of the plurality of features. The classification information provides, for example, classification of different body parts of an imaged subject that can be used to condition the image transformation process to reduce the generation of abnormal images.

### TECHNICAL FIELD

The present disclosure relates to a method for processing ultrasound images and, in particular, to a method of processing ultrasound images to derive a rendered image.

### BACKGROUND

Ultrasound images are formed by sending pulses of high frequency sound waves into tissue from an ultrasound probe. These pulses echo off tissues within a patient with different reflection properties and are returned to and detected at the probe. The ultrasound scanner uses the measurement of these reflected pulses to construct an image. Three-dimensional (3D) ultrasound data can be obtained by a specifically designed probe for collecting the 3D data. Alternatively, 3D ultrasounds data may be obtained by collecting a plurality of ultrasound images obtained by moving an ultrasound probe. For example, the ultrasound probe may be tilted, with reflected pulses being captured at different orientations of the probe. These reflected pulses captured at different orientations of the probe are processed to produce a three-dimensional array comprising a plurality of voxels representing the imaged structure. After capturing the 3D data, a two-dimensional (2D) image is produced from a selected angle by applying a volume rendering technique to the 3D data. The 2D image that is produced may comprise a helpful visualisation of the raw information captured by the ultrasound scanner.

Image generative models have been developed in recent years, which are machine learning models that are trained to generate new images based on a particular input. Some generative models may be trained specifically to generate a particular type of image and may receive as an input, only a random seed (e.g. a vector) from which it generates an output image. Other models may be capable of operating in a mode (referred to as txt2img) in which, in addition to the seed, text information is used as a prompt, which causes the model to generate an image reflecting the text prompt. Some models may be capable of operating in a mode (referred to as img2img) in which, in addition to the seed, an input image is provided and the model generates an output image that reflects a transformation of that input image. In this case, the model may be referred to as an image transformation model.

### BRIEF DESCRIPTION OF DRAWINGS

Some embodiments of the disclosure will now be described, by way of example only and with reference to the accompanying drawings, in which:

FIG. 1A illustrates an example of a computing device according to embodiments of the application;

FIG. 1B illustrates an example of a computing server according to embodiments of the application;

FIG. 1C illustrates an example of a computing device in communication with the computing server;

FIG. 2 illustrates an example of a system comprising an ultrasound system for producing ultrasound imaging data and an image processing system for producing transformed images of the ultrasound imaging data;

FIG. 3 illustrates an example of an ultrasound image of a foetus being transformed along with conditioning information;

FIG. 4 illustrates an example of neural network;

FIG. 5A illustrates an example of a first part of a convolutional neural network;

FIG. 5B illustrates an example of a second part of a convolutional neural network;

FIG. 6A illustrates a generative adversarial network (GAN) in which conditioning information is input to the networks;

FIG. 6B further illustrates a simplified example of the networks of the generative adversarial network (GAN);

FIG. 7 illustrates a diffusion network for performing a transformation of an image;

FIG. 8 illustrates a U-net for denoising an image as part of processing of that image by the diffusion network;

FIG. 9A illustrates a further network for modifying the output of the diffusion network based upon conditioning information;

FIG. 9B illustrates in more detail, the further network for modifying the output of the diffusion network based upon conditioning information;

FIG. 10 illustrates an example training method according to embodiments; and

FIG. 11 illustrates an example method according to embodiments.

### DETAILED DESCRIPTION

It is proposed to apply image transformation techniques to ultrasound images to improve the quality of these images. However, such image transformation techniques are often prone to failure, and result in the generation of abnormal images.

According to certain embodiments there is provided, a computer implemented method for processing ultrasound imaging data comprising: obtaining a two-dimensional ultrasound image; deriving from input data, classification information for each of a plurality of features in the two-dimensional ultrasound image, the input data comprising at least one of: the two-dimensional ultrasound image or three-dimensional ultrasound data corresponding to the two-dimensional image; deriving a rendered image by supplying to an image transformation machine learning model: the two-dimensional ultrasound image as an input image; and the classification information for each of the plurality of features. The rendered image may also be referred to as a further image. The rendered image output by the image transformation machine learning model may be a photo realistic rendered image that is distinct from the two-dimensional ultrasound image (which may also be a rendered image output by a rendering system).

The inventors have found that it is possible to perform image transformation of ultrasound imaging data with high reliability by first deriving, for different features in the input data, classification information. The classification information provides, for example, classification of different body parts of an imaged subject that can be used to condition the image transformation process to reduce the generation of abnormal images.

According to a second aspect, there is provided a computer system comprising at least one processor and at least one memory comprising a set of computer readable instructions which when executed by the at least one processor cause the system to perform the method of the first aspect.

According to a third aspect, there is provided a computer program comprising computer readable instructions, which when executed by at least one processor of a computer system cause the system to: perform the method of the first aspect.

According to a fourth aspect, there is provided a non-transitory computer readable medium storing the computer program according to the third aspect.

Embodiments will be described in more detail with reference to the accompanying Figures.

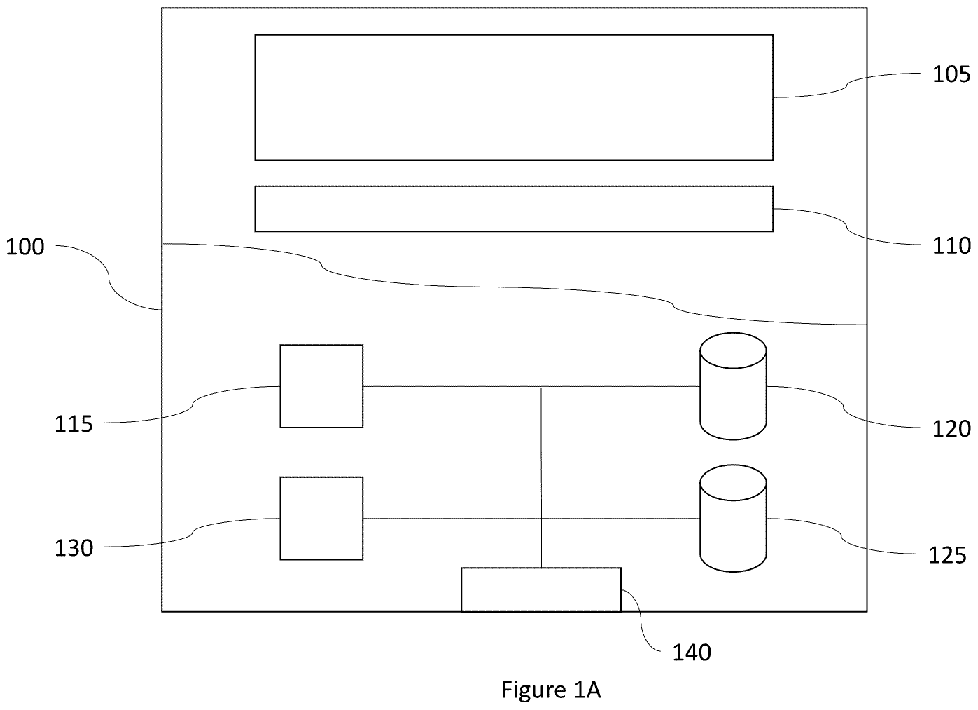

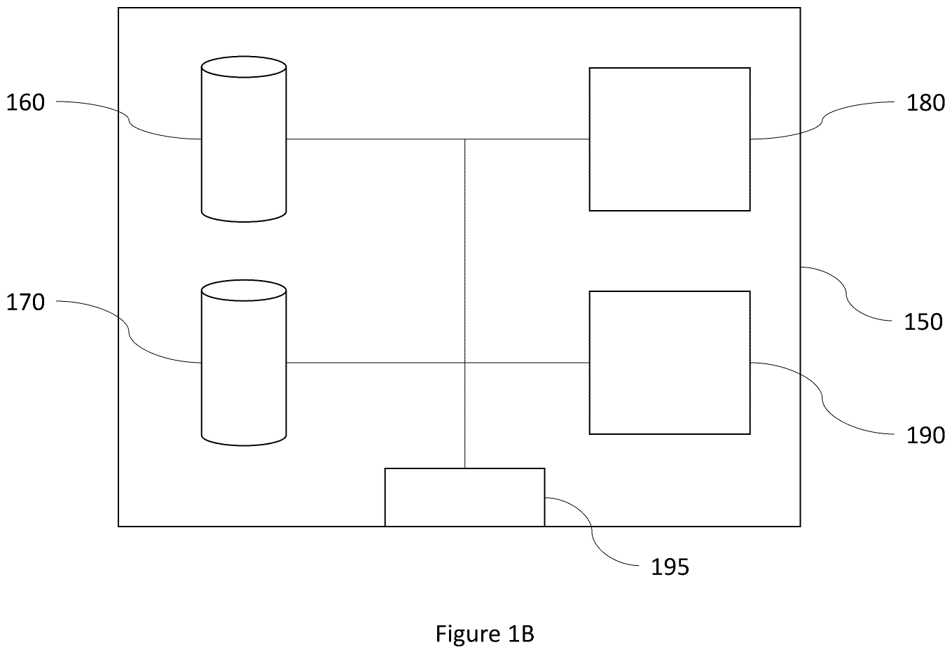

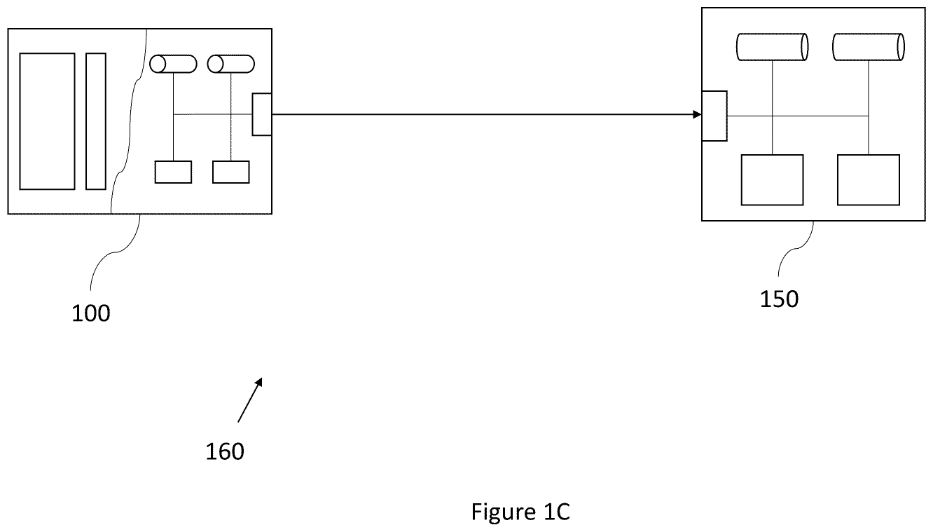

Reference is made to FIG. 1, which illustrates an example data processing system 100 in which embodiments may be implemented. The system 100 may be a server, a terminal or workstation, a personal computer (PC), or some other form of device.

The system 100 may comprise an interface 140 over which it sends and receives signals. The interface 140 may be a wired or wireless interface. For instance, the interface 140 may comprise a wired interface for connection to a wired network (e.g. a local area network and/or the internet). Alternatively or in addition, the interface 140 may comprise transceiver apparatus configured to send and receive communications over a radio interface. The transceiver apparatus may be provided, for example, by means of a radio part and associated antenna arrangement. The antenna arrangement may be arranged internally or externally to the system 100.

The system 100 is provided with at least one data processing entity 115, at least one random access memory 120, at least one read only memory 125, and other possible components 130 for use in software and hardware aided execution of tasks it is designed to perform, including control of, access to, and communications with access systems and other communication devices. The at least one random access memory 120 and the hard drive 125 are in communication with the data processing entity 115, which may be a data processor. The data processing, storage and other relevant control apparatus can be provided on an appropriate circuit board and/or in chipsets. A user may controls the operation of the system 100 by means of a suitable user interface such as key pad 110, or by voice commands. A display 105 may be included on the system 100 for displaying visual content to a user. The system 100 may also comprise a speaker for providing audio content.

The memory of the system 100 (i.e. the random access memory 120 and the hard drive 125) may be configured to store computer readable instructions for execution by the data processor 115 to perform the data processing functions described herein as being performed by the system 100. Alternatively, the components 130 may comprise hardware components, such as a field programmable gate array (FPGA) or application specific integrated circuit (ASIC), for performing the operations described herein as being performed by the system 100. In some embodiments, the operations described herein as being performed by the system 100 may be performed by a combination of the hardware components or by a processor executing computer readable instructions.

Although the system 100 is shown in FIG. 1A as a single unified device 100, in other embodiments, the system 100 may comprise a plurality of interconnected devices. Reference herein to operations performed by the system 100 are understood to be references to operations performed by processing circuitry (e.g. circuitry 115, 130) of the system 100 performing those operations. In particular, the references to operations performed by the system 100 may be understood to be references to operations performed by the processing circuitry executing computer readable instructions stored in the storage 120, 125 of the system 100.

Reference is made to FIG. 1B, which illustrates an example computer system 150 that may be used for performing processing described herein. In particular, the example computer system 150 may be used for performing the training of machine learning models discussed herein. Additionally or alternatively, the computer system may be used to perform the operating of machine learning models. The system 150 is shown as a single enclosed apparatus. However, in some embodiments, the system 150 is a distributed system, with multiple data processing apparatuses operating in communication with one other. The system 150 may comprise a server, back-end system, or the like.

The system 150 comprises at least one random access memory 160, at least one hard drive 170, at least one data processing unit 180, 190 and an input/output interface 195. The memories 160, 170, store data for inputting to the one or more models and for storing results of the processing performed during execution of the one or more models. The memories 160, 170 may store the training data, which is applied to train the machine learning models. The memories 160, 170 additionally store computer executable code which, when executed by at least one data processing unit 180, 190, provide the one or more machine learning models. At least one of the data processing units 180, 190 performs one or more of: the processing associated with the one or more models, the training of the models, and any necessary pre-processing of data for use by the models. Via the interface 195, the system 150 receives the data items for constructing the training data sets and/or the data items for constructing the operating data sets. The system 150 additionally sends via the interface 195, the results produced by running the models on input data.

Reference is made to FIG. 1C, which illustrates a system 160 comprising the device 100 in communication with the system 150. In this example, the system 150 may store and operate one or more machine learning models. The system 150 may, for example, be a cloud based server or a graphics processing unit (GPU), which is configured to process data received from the device 100 by applying that data to the one or more machine learning models and returning the results of that processing to the device 100.

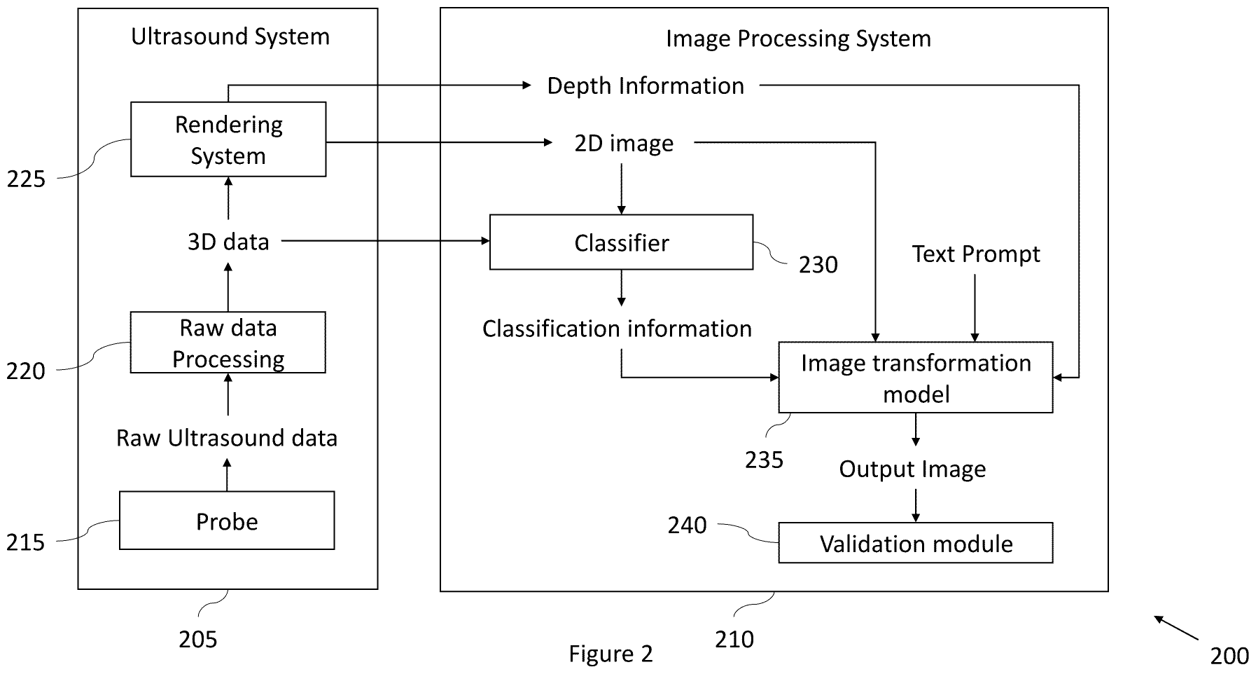

Reference is made to FIG. 2, which illustrates an overview of the process by illustrating the different modules belonging to a system 200 and the items of data produced by these modules and involved in generating the output image. The system 200 comprises an ultrasound system 205 configured to obtain the raw ultrasound data, to generate 3D data from the raw ultrasound data and to perform rendering to generate 2D images from the 3D data. The system 200 also comprises an image processing system 210, which is configured to receive the 2D images from the ultrasound system 205 and to generate output images from those 2D images. The image processing system 210 may correspond to any of the systems 100, 150, 160 described above, in which case the relevant system 100, 150, 160 is configured to only perform the processing of the outputs of the ultrasound system 205. Alternatively, the entire system 200 may correspond to any of the systems 100, 150, 160, in which case the relevant system 100, 150, 160 is configured to also perform the rendering of the 3D data. Reference to any operations performed by modules or components of the system 200 (e.g. operating machine learning models) may be understood to refer to operations performed by at least one processor of any of the systems 100, 150, 160 executing computer readable instructions of a computer program held in at least one memory of that system 100, 150, 160 in order to perform those operations. The training of machine learning models that perform processing as part of the systems may be performed by the at least one processor of the any of the systems 100, 150, 160 executing those computer readable instructions or may be performed by another system (which is not shown in the Figures) that provides the trained machine learning model to the relevant one of systems 100, 150, 160.

As shown in FIG. 2, an ultrasound system 205 is part of the system 200. The ultrasound system 205 comprises a probe 215, which may be tilted to capture ultrasound data at different orientations or it may be able to capture volumetric data directly. The probe 215 may also be referred to as a transducer. The ultrasound system 205 comprises processing circuitry configured to provide the raw data processing modules 220 and the rendering system 225.

The probe 215 captures raw ultrasound data, providing 3D data about the imaged subject. The probe 215 may be used to image a foetus in the womb, for example. The probe 215 may output the raw ultrasound data to the raw data processing module 220, which may process the raw ultrasound data to produce volumetric data. The volumetric data comprises an array of voxels, in which the value associated with each voxel is indicative of the presence of different types of tissue or substance. The 3D data is supplied to the rendering system 225.

The rendering system 225 is configured to generate a 2D image from the 3D data. The 2D image generated is a 2D projection of the 3D data. The rendering system 225 may in addition to the 3D data, receive as an input, certain parameters enabling it to provide the 2D image. The parameters include the position and orientation of a camera relative to the volume represented by the 3D data. The 2D image is created from the perspective of this camera. The parameters may additionally include lighting information for providing illumination in the 2D image.

Different techniques may be applied by the rendering system 225 to perform the volume rendering to generate the 2D image. Direct volume rendering may be performed by the system 225 by computing the intensity of different points in the 2D image. In an example, the direct volume rendering may be performed to calculate the intensity I at a point x on the view port, received along a direction w by applying an integral. Specifically, the intensity may be given by:

$$I ( x , ω ) = {I}_{0} T ( x + {s}_{0} ) + {\int }_{0}^{s 0} T ( x + s ) ( S ( x + s ) + E ( x + s ) ) ds \qquad Equation 1$$

where T is the transmission function integrating the local attenuation along the path between the view place and a position s.

$$T ( s ) = {e}^{- {\int }_{0}^{S} μ ( x ) dx} \qquad Equation 2$$

E represents the emission at a point along the path and S represents the scattering and reflection contribution.

In some embodiments, the rendering system 225 may apply global illumination to the 2D image to add more realistic lighting to the image. The rendering system 225 may, in this case, determine the intensity of various points in the image, however, without some of the gross approximation used in traditional direct volume rendering (DVR). In the case in which global illumination is applied, the scattering function S may be evaluated as a recursive integral over the irradiance and a function representing the percentage of light reflected in a given direction.

The output of the rendering system 225 includes a 2D image from a certain view point, i.e. camera position and orientation. The rendering system 225 may also output depth information determined based upon the 3D data. The depth information may take the form of a depth map indicating the depth of the surfaces shown in the 2D image. The depth information may indicate the position of the surfaces in the 2D image, and may also indicate the orientation of these surfaces by including the surface normals in the depth information.

The ultrasound system 205 provides the 2D image generated by the rendering system 225 to the image processing system 210. The ultrasound system 205 may also provide the 3D data and/or the depth information to the image processing system 210.

A classifier module 230 is provided by the processing circuitry of the image processing system 210. The classifier 230 determines and outputs classification information based upon either the 2D image output by the rendering system 225 or based upon the 3D data. The classifier 230 may comprise one or more convolutional neural networks (CNNs) configured to receive the input ultrasound image data (either the 2D image or the 3D data) and to provide classification for a plurality of features in the image data. In the case that the classifier 230 processes the 3D data, the classifier 230 may output 3D classification information. The classifier 230 may then perform an additional rendering step on this classification information to produce a 2D classification map, which corresponds to the 2D image output by the rendering system 225.

The classification image may comprise a classification map that is suitable to be overlaid over the 2D image and indicate the classification—e.g. nose eyes, mouth, ears—of different parts of the 2D image. The classification information may be a segmentation map. Alternatively, the classification information may be pose information. In the case that the 2D image and 3D data are image data of a foetus, the classifier 230 may identify within the image data, parts corresponding to different body parts—e.g. nose, eyes, mouth, ears—of the foetus.

When the classification information is provided in the form of pose information, the classifier 230 identifies different parts—e.g. nose, eyes, mouth, ears—of the 2D image and estimates the position and orientation of these different parts. The pose information associated with each part may comprise a matrix (e.g. a transformation matrix), representing the position and orientation of the object. Each object for which a matrix is defined may be selected from a predefined set of objects representing different parts—e.g. node, mouth—of the image. The pose information, therefore, includes an identifier of the object type, in addition to the position and orientation information associated with the object.

The processing of the image processing system 210 also provides an image transformation model 235, which receives the 2D image and the classification information, and provides an output image on the basis of this information. The image transformation model 235 may additionally receive the depth information output by the rendering system 225 and use this depth information to generate the output image. The image transformation model 235 may additionally receive text information input to the image processing system 210 by a user and may use this text information to generate the output image. The image transformation model 235 comprises one or more machine learning models configured to perform image generation on the basis of an initial input image (in this case the 2D image derived from the ultrasound data) and on the basis of certain conditioning information, e.g. the classification information, text prompts, and depth information. Examples of the machine learning models that may be used to determine the output image will be described in further detail below.

It was been described that the raw data processing module 220 outputs a set of 3D data based on the raw ultrasound data. In some embodiments, this 3D data may comprise a single set of 3D data, e.g. representing a state of the imaged subject at a particular time. In other embodiments, the 3D data may comprise a time series of 3D data showing the state of the imaged subject over time. In the case that data represents the state of the imaged subject at a point in time, the rendering system 225 may produce a single 2D image based on this state and the image transformation model 235 may produce a single output image based on this state. However, in the case in which a time series of 3D data is produced, the rendering system 225 may produce a plurality of 2D images, each of which is associated with a different point in time. The classifier 230 may provide a set of classification information corresponding to each of the plurality of 2D images. These plurality of 2D images provide a video of the imaged subject. The image transformation model 235 may, based on these plurality of images produced by the rendering system 225 and plurality of set of classification information, produce a transformed video.

In further embodiments, the rendering system 225 may receive a single set of 3D data and perform rendering on this data to produce a plurality of 2D images, where each of those images may be associated with a different view/camera orientation. The image processing system 210 may input each of those rendered images into the image transformation model 235 to obtain a neural radiance field (NeRF) object.

In some embodiments, once the image processing system 210 has obtained the output image produced by the image transformation model 235 that output image may be further processed by the image processing system 210, e.g. by performing context aware infill to provide additional detail to the image. The context aware infill may be performed in dependence upon by a separate text prompt supplied by a user.

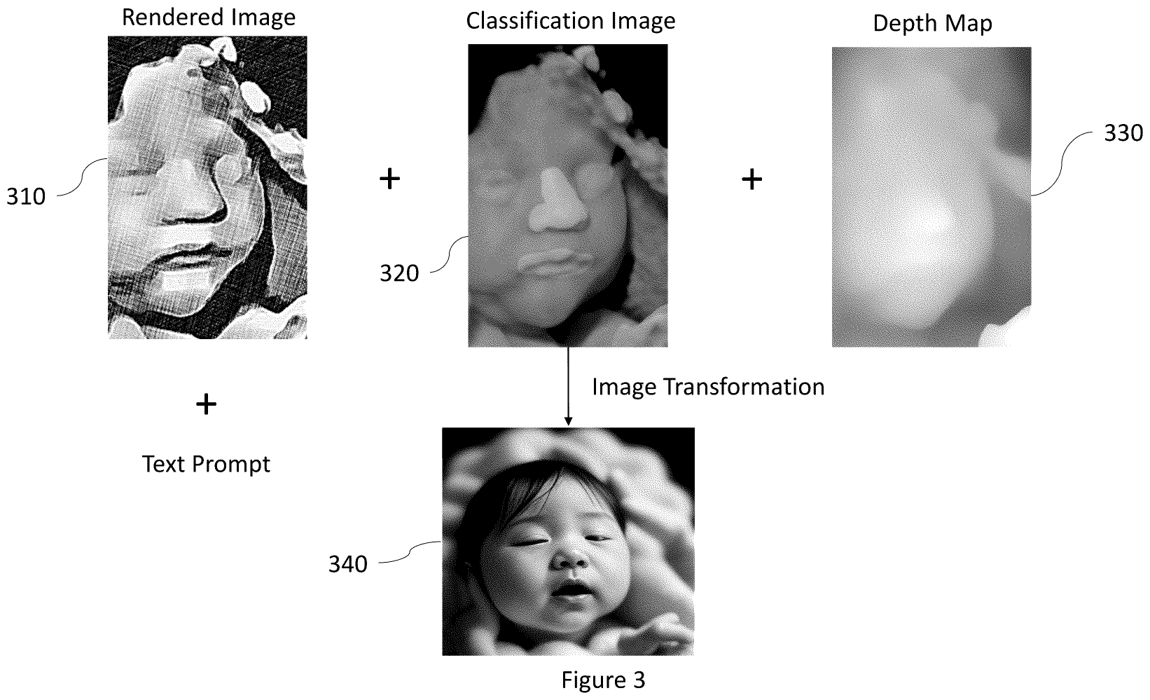

Reference is made to FIG. 3, which illustrates an example of the different data involved in the process illustrated in FIG. 2. In this case, the ultrasound image data is image data of a foetus. FIG. 3 shows an example 2D image 310 that may be output by the rendering system 225. FIG. 3 also shows a text prompt, which may be optionally input into the image processing system 210 by user input. The text prompt may describe certain features of foetus that are input by the human user. For example, the text prompt may indicate that the foetuses eyes are open or closed. The text prompt may indicate the ethnicity of the foetus.

FIG. 3 shows an example of the classification image (corresponding to the 2D image 310) 320 that is output by the classifier 230. FIG. 3 also shows an example depth map 330, which may be output by the rendering system 225. The image transformation model 235 takes as inputs, the 2D image 310, the classification image 320, and optionally the depth map 330 and text prompt. The image transformation model 235 outputs a further image 340, which is a photo realistic image. The further image 340 is referred to as the rendered image or the photo realistic rendered image.

Once the output image is generated by the image transformation model 235, the system 210 may perform a validation check (at the validation module 240) of the image to determine whether or not the image satisfies certain requirements. The validation module 240 may comprise a machine learning model that is trained to determine whether or not the output image meets a validation standard. The validation module 240 may comprise a machine learning model that is trained to determine whether or not the output image meets a validation standard. The machine learning model may be trained based upon a set of user classified images, where each image in the set of user classified images is labelled as a good image (i.e. an image that would pass the validation check) or a bad image (i.e. an image that should not pass the validation check). This machine learning model may be a convolutional neural network (CNN), which is configured to, in response to receipt of an output image produced by the image transformation model 235, output a value representing a quality score. The system 210 would compare the quality score to a threshold to determine whether or not the output image meets this quality score.

If the output image does not pass the validation check, the process for producing the output image may be repeated by the image transformation model 235. When the output image is generated again, the image transformation model 235 may use a different seed. The different seed may comprise a different set of noise that is applied to the 2D input image as part of the transformation process performed by the model 235. Additionally or alternatively, when the output image is generated again, the image transformation model 235 using a different text prompt supplied by a user. Additionally or alternatively, when the output image is generated again, the image transformation model 235 may use a different image generated based on the same 3D data by the rendering system 225. This different image may be generated by the rendering system 225 by using different lighting or by using a different view (i.e. camera) orientation.

Once a new output image is obtained, the validation module 240 again performs a check to determine whether this new output image satisfies the requirements of the validation. If the output image passes the validation check, the processing system 210 may control the display 105 to show the output image.

Multiple machine learning models may be involved in the processing performed by the image processing system 210 as will be described. The classifier module 230 may comprise a CNN configured to derive the classification information for a plurality of features within the input image. The image transformation model 235 may comprise one or more generative machine learning models configured to perform the image transformation. For example, the image transformation model 235 may comprise a generative adversarial network (GAN) or may comprise a diffusion model. The validation module 240 may comprise a CNN for determining a quality score of the image output by the image transformation model 235. The operation of these various models is explained below in more detail.

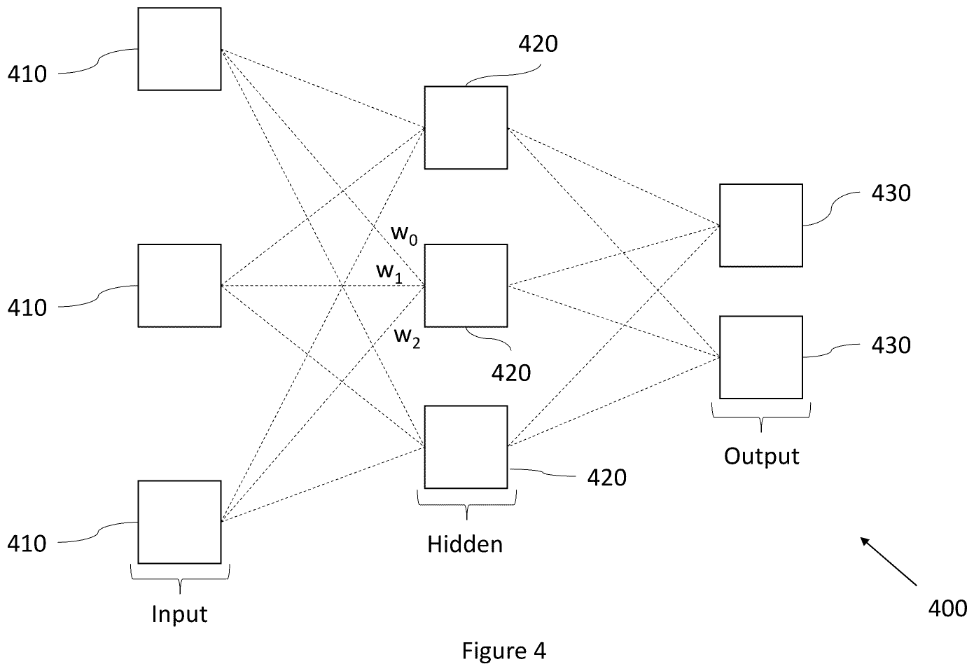

FIG. 4 as a schematic illustration of a neural network 400. The neural network 400 comprises input nodes 410, hidden nodes 420 and output nodes 430. In practice, there are likely to be many more nodes in the network 400 than those shown, and more hidden layers than the one shown. Each input node 410 receives a single value of the input data and produces at its output, an activation or node value, which is generated by supplying the input value to an activation function (e.g. a sigmoid). Each of the input nodes 410 is connected to each of the hidden nodes 420. A matrix of weights defines the connectivity between the input nodes 410 and the hidden nodes 420. A vector of the node values output from the input nodes 410 is scaled by a vector of respective weights at the input of each of the hidden nodes 420, each weight defining the connectivity of one of the input nodes 410 with a connected one of the hidden nodes 420. The weights applied at the inputs of one of the hidden nodes 420 are shown in FIG. 4 as w₀ . . . w₃. At each hidden node 420, the input value at that node is given by the dot product of its associated weights vector and the output values of the input nodes 410. The activation function is then applied to the input values at the hidden nodes 420 to provide the output values of those nodes 420. The output vector of the hidden nodes 420 is supplied to each of the nodes 430 in the next layer of the network 400 and used in a similar manner to generate the output values for that next layer.

The network 400 may be trained through supervised or unsupervised learning. In one embodiment, the network 400 is trained through supervised leaning by determining at least one set of output values based on at least one set of input values included in the training data. The output values are compared to known labels in the training data and an error or loss is calculated (i.e. based on a difference between the output values and the labels). The error or loss is then back-propagated through the network 400 to update the weights, such that the network 400 is trained to better approximate the labels from the input values. In the next cycle, the revised weights are used with further training data to further update the weights to more closely reproduce the labels of the further training data based on the input values of the further training data. In this way, the network 400 can be trained to perform a specific task.

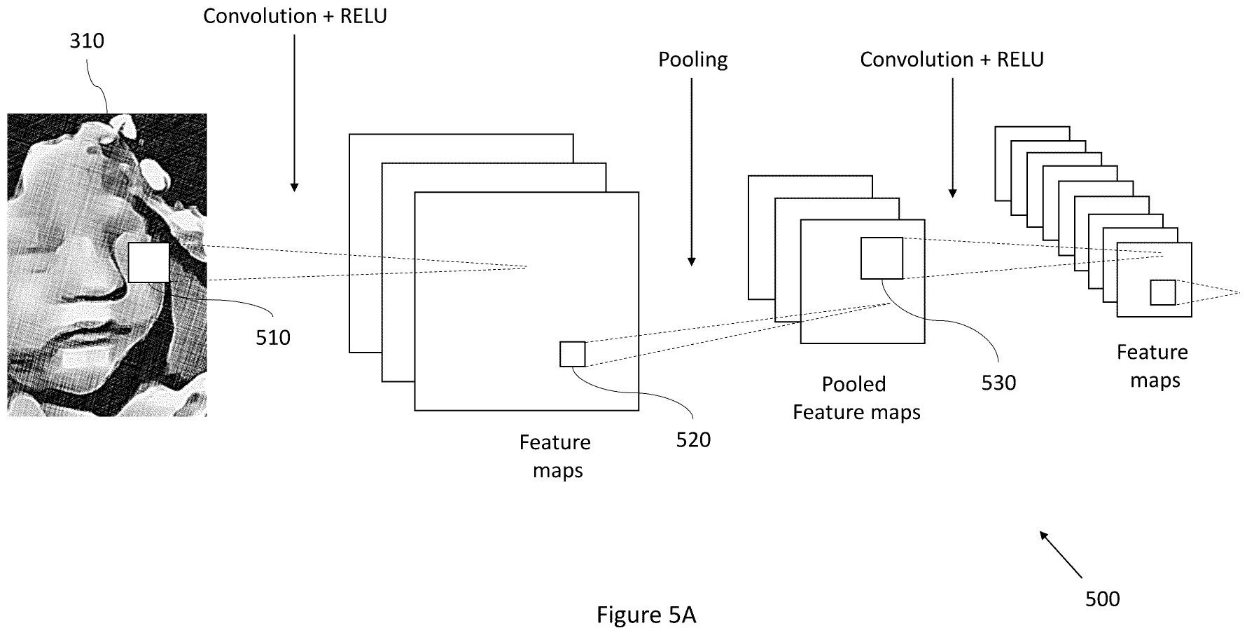

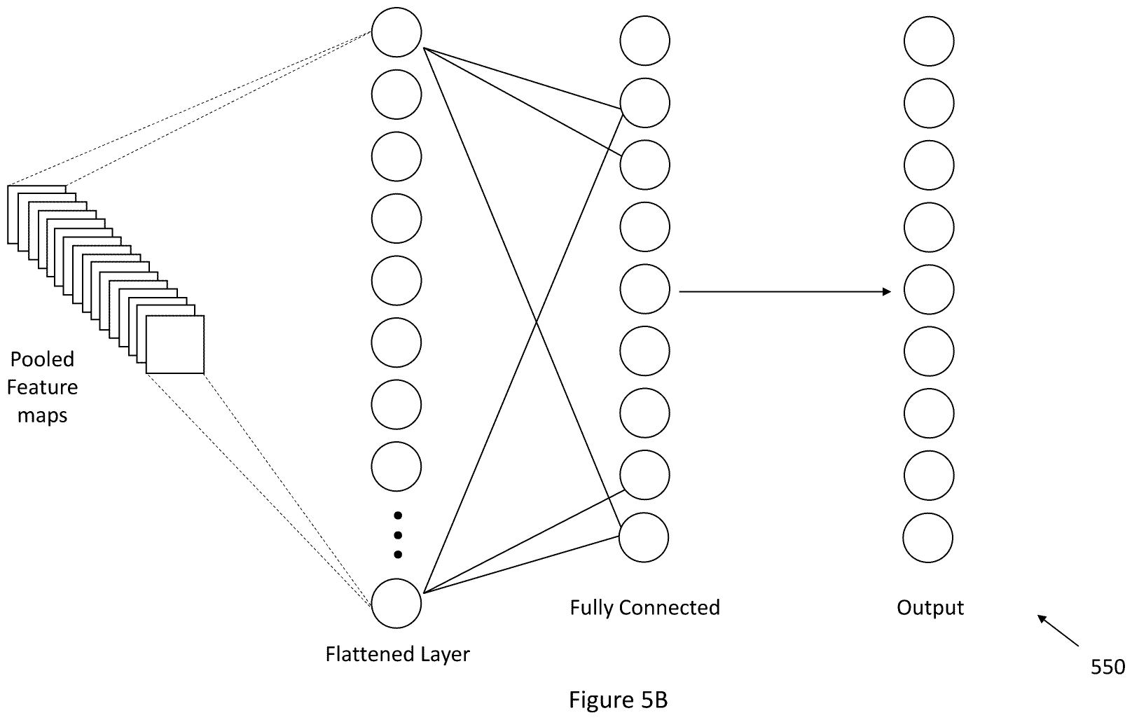

Reference is made to FIGS. 5A and 5B, which illustrate an example of the operation of a convolutional neural network, which can be used to identify certain features within images and perform classification of those features. In the example shown, the input image is the 2D rendered image foetus image 310. The convolutional neural network may be used to derive a set of output values indicating the classification of different parts of the input image 310.

A kernel 510 is applied to determine a convolution of the input image 310 with the kernel 510. The output of this convolution is subject to an activation function to add non-linearly. The activation function used in FIG. 5A is a rectified linear activation unit (RELU), which, if the input is positive, outputs the input, and, if the input is not positive, outputs zero. A plurality of feature maps are generated from the input image by performing convolutions between the input image and different kernels, where each kernel represents a different basic feature, e.g. a vertical line or horizontal line.

Each of the feature maps produced by the convolution and activation function is then subject to a pooling process, which is performed to reduce the spatial size of the convolved feature. The pooling process involves translating a kernel 510 across the feature map to sample groups of pixels and returning the maximum or average value from each of the sampled groups of pixels in the feature map. The resulting pooled feature maps are each subject to a further convolution process (with the RELU function applied) using the different kernels to generate a further set of feature maps from which pooling is again performed.

As shown in FIG. 5B, the pooled feature maps resulting from multiple stages of convolution and pooling are flattened to produce a one dimensional array (shown as Flattened Layer), which is provided as a set of input values to a feed forward neural network. The resulting output values may represent the classification of different parts of the input image 310. The classifier 230 may convert these output values to a classification map for the image 310 or into pose information for the image 310.

The convolutional neural network may be trained by comparing output values for different images to labels of those images and adjusting the weights of the feed forward portion of the convolutional neural network.

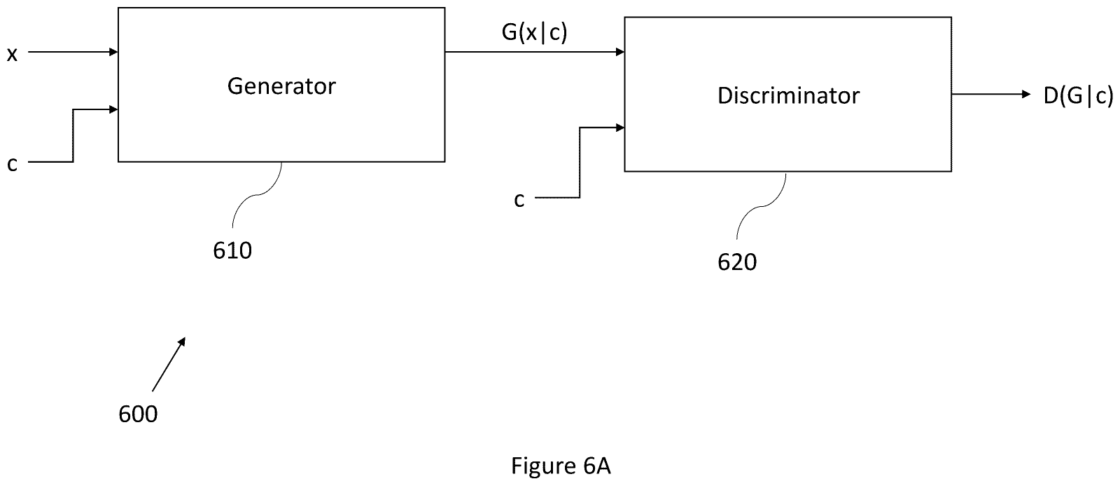

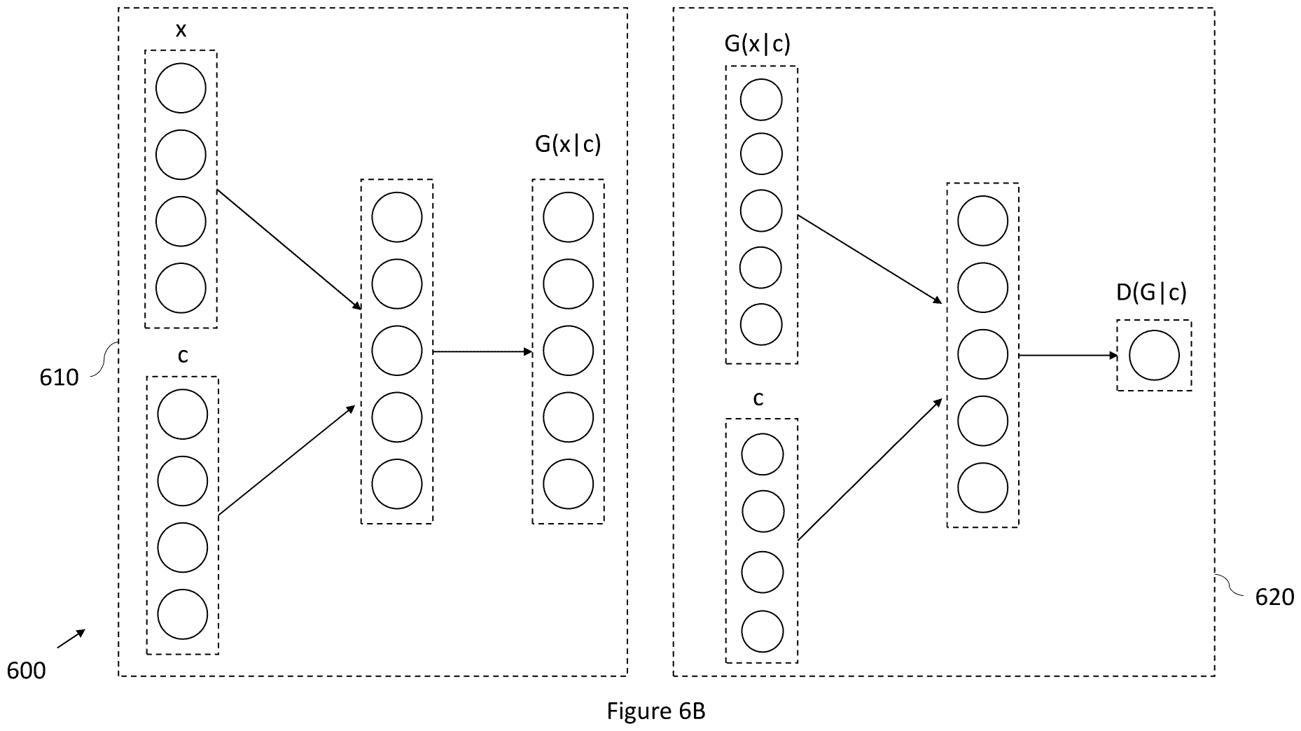

In some embodiments, the image transformation model 235 may comprise a generator model of a generative adversarial network (GAN). Reference is made to FIGS. 6A and 6B, which illustrates an example of a GAN 600.

FIG. 6A illustrates two components of a GAN 600. A first component 610 is referred to as the generator 610 and is configured to generate images based upon a particular input, shown as x. The input may be a random vector or may be data representing an image.

The generator 610 may also receive condition information, shown as c, which is provided as an additional input layer into the generator 610. The generator 610 produces an output image, G(x|c). In embodiments, the input x is one of the images provided by the rendering system 225 and the condition information includes classification information for the image as determined by the classifier 230. The classification information may take the form of a set of inputs representing a classification map, e.g. data indicating the classification of different pixels in the 2D image. Alternatively, the data may take the form of pose information, e.g. comprising for each different classified object within the 2D image, an indication of the type of the object, the position and the orientation of the object. Once the generator 610 has been trained, the generator 610 is configured to output the higher quality images (e.g. rendered image 340) discussed above.

The GAN 600 further includes a second component, referred to as the discriminator 620, which is used as part of the training process for training the generator 610. The discriminator 620 is trained to provide scores for images output by the generator 610, where the scores indicate how closely the generated images align with a set of training images. In other words, the discriminator 620 is trained to identify whether an image is a real image or a generated image. The discriminator 620 receives as an input, the data G(x|c) output by the generator 610, which represents an input image. The discriminator 620 also receives the same condition information, c, as received by the generator 610 at an additional input layer at the discriminator 620.

The generator 610 and the discriminator 620 are trained as part of a same training process in which the loss function of the discriminator 620 is used to update the model parameters of both the generator 610 and the discriminator 620. This training process may be performed by computing system 150. The generator 610 produced by the training process may be provided as the image transformation model 235 for performing image transformations of the 2D images output by the rendering system 225, using data representing the classification information from the classifier 230 as condition information. The generator 610 may also receive as condition information, data representing the depth information and/or data representing the text prompt.

FIG. 6B illustrates a simplified example of a generator 610 and a discriminator 620 in which certain example layers are illustrated. As shown, the generator 610 receives an input, x, which represents an input image. The generator 610 also receives condition information, c, which includes classification information for the features in the input image, x. Both x and c are mapped to hidden layers of the neural network of the generator 610 with a given activation function. In response to these inputs, the generator 610 produces an output, G(x|c), which represents an output image.

The discriminator 620 receives an input, G(x|c), which represents an input image. The discriminator 620 also receives condition information, c, which includes classification information for the features in the input image, x. Both x and c are mapped to hidden layers of the neural network of the discriminator 620 with a given activation function. In response to these inputs, the discriminator 620 produces an output, D(G|c), which represents a score for the input image G(x|c).

In some embodiments, the image transformation model 235 may comprise a diffusion model, which is configured to perform transformation of an image.

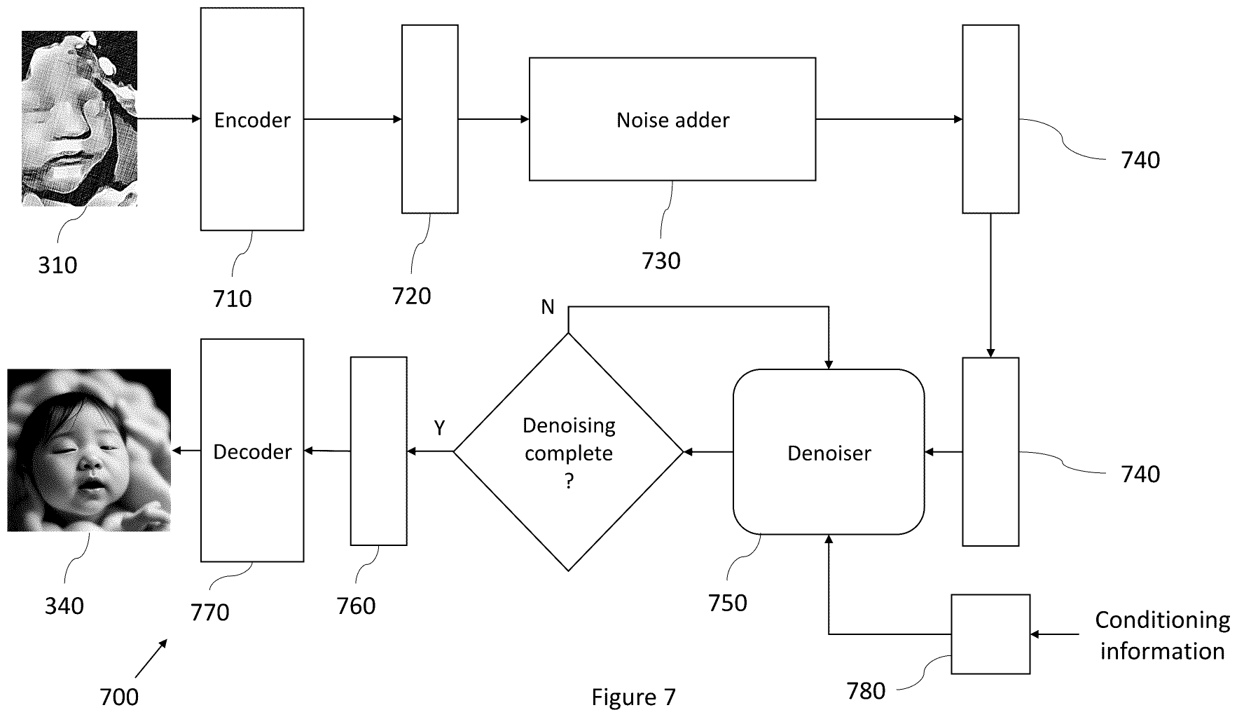

Reference is made to FIG. 7, which illustrates how a diffusion model may operate to transform an input image (input image 310 in this example) into an output image (rendered image 340 in this example). The diffusion model 700 comprises an encoder 710, which is configured to encode the input image 310 to transform the image from pixel space to a latent space. The image 720 output from the encoder 710 represents the input image 310 in latent space. A diffusion model 700 comprises a module 730, which is configured to add noise to the input image 310 to generate a noisy image 740. The noisy image 740 retains some of the information from the original image 310. The noisy image 740 is input to a denoiser module 750 of the image transformation model 700. The denoiser module 750 comprises a CNN that is trained to iteratively remove noise from the image 740. The image denoising is performed over a number of iterations until the output image 760 is produced. The output image 760 is provided to the decoder 770, which is configured to convert the image 760 into pixel space to produce rendered image 340, which is suitable for display.

Additionally, conditioning information may be applied to the denoising process to control the transformation process. The conditioning information is supplied to an encoder 780, which converts the condition information into a set of values suitable for applying to the denoiser 750 via a cross-attention mechanism. For example, the conditioning information may comprise a text prompt, which is converted by the encoder 780 into a set of numerical values, which are applied via a cross-attention mechanism to the denoiser 750.

The diffusion model 700 may be trained to create output images in an adversarial manner by training a discriminator 620 to assign quality scores to the output images of the diffusion model 700, indicating the extent to which the output images correspond to desired outputs.

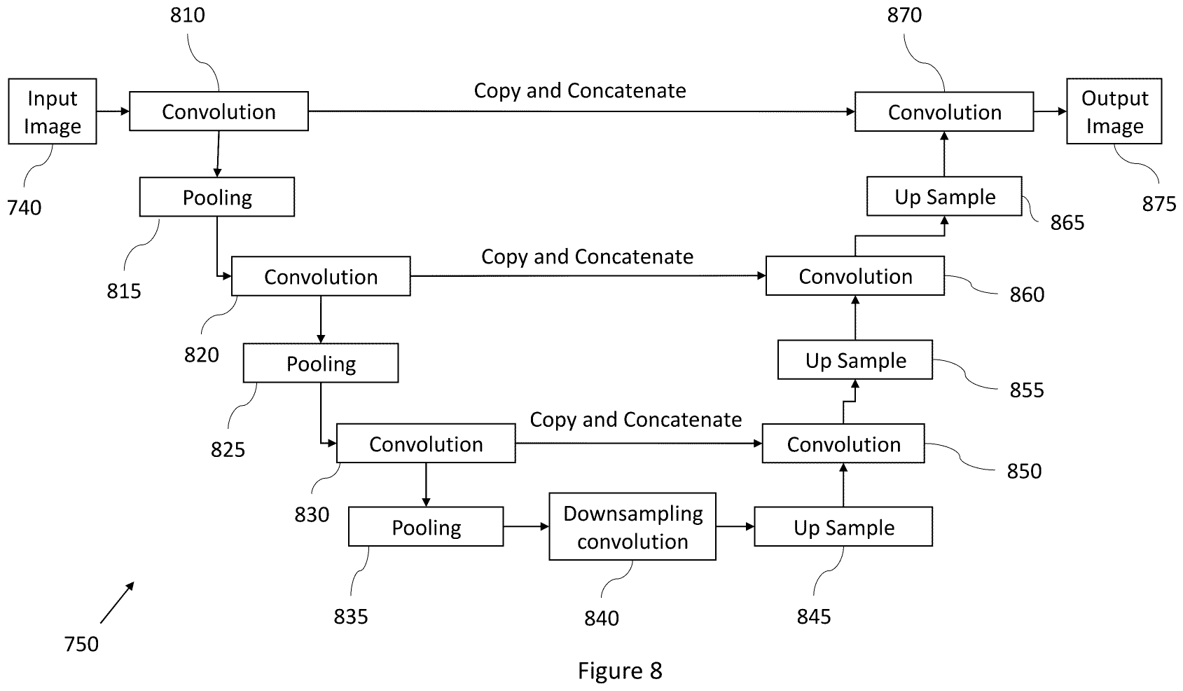

The denoiser 750 may comprise a U-net model. Reference is made to FIG. 8, which illustrates an example of a U-net 750. The U-net 750 comprises a first set of encoding stages comprising convolution stages 810, 820, 830, 840 and pooling stages 815, 825, 835.

The U-net 750 receives an input image 740, which is applied to the downsampling convolution stage 810. The downsampling convolution stage 810 performs convolutions on the input image 740 and applies an activation function to generate a set of feature maps. A part of each feature is stored to be concatenated with a further feature map in a latter part of the process. The pooling process 815 is applied to the feature maps resulting from the convolutions to generate pooled feature maps. The convolution and pooling processes are repeated to further downsample the data at stages 820, 825, 830, 835, 840.

In a second part of the network 750, the pooling modules 815, 825, 835 are replaced with up sampling stages 845, 855, 865. Between the upsampling stages 845, 855, 865 are a set of convolution stages 850, 860, 870, at which a convolution is applied. Each convolution stage 850, 860, 870 is applied to a result of concatenating an output of an earlier convolution stage 810, 820, 830, with the output of a preceding upsampling stage 845, 855, 865.

The result of the processing by the U-net 750 is the output image 875, which represents the input image 740 with at least some of the noise removed. The U-net may be applied multiple times to remove noise from the image 740.

During the training process, the U-net may be trained by the adjustment of filters applied during the convolution operations to appropriately denoise the image to a produce a transformed image.

In some embodiments, as described, conditioning information may be applied to the network 750 to adjust filters of the network 750. This may be applied for certain conditioning information, e.g. text, by applying a cross-attention mechanism between the encoded conditioning information and the denoising network 750. For spatial conditioning information, such as the classification information, an additional approach may be adopted by which conditioning information may be applied.

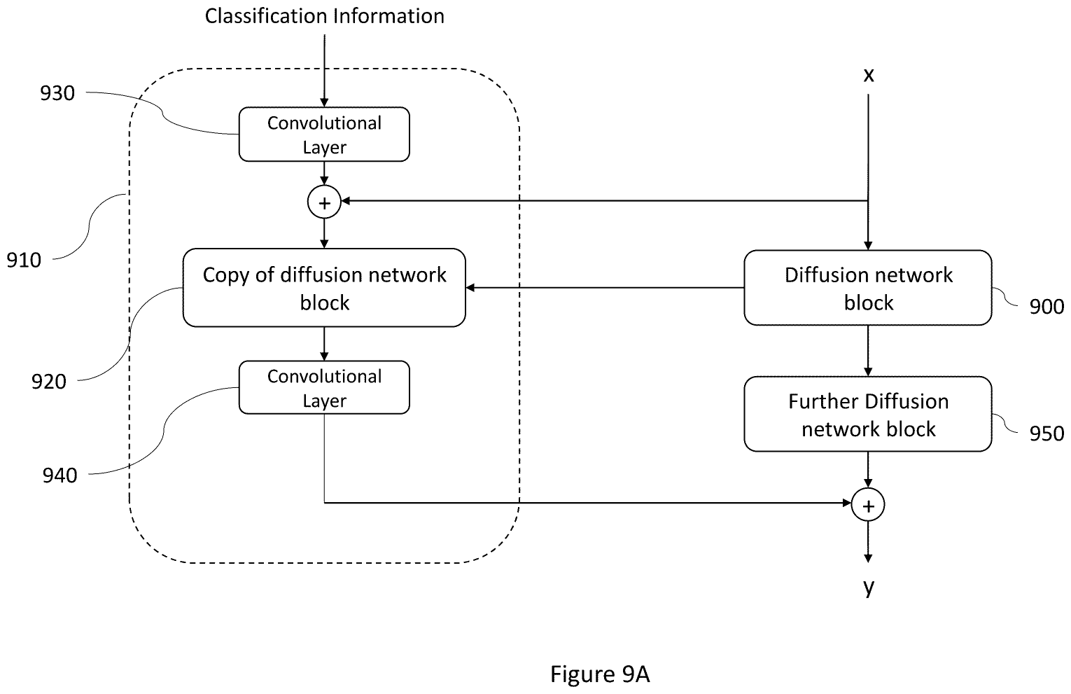

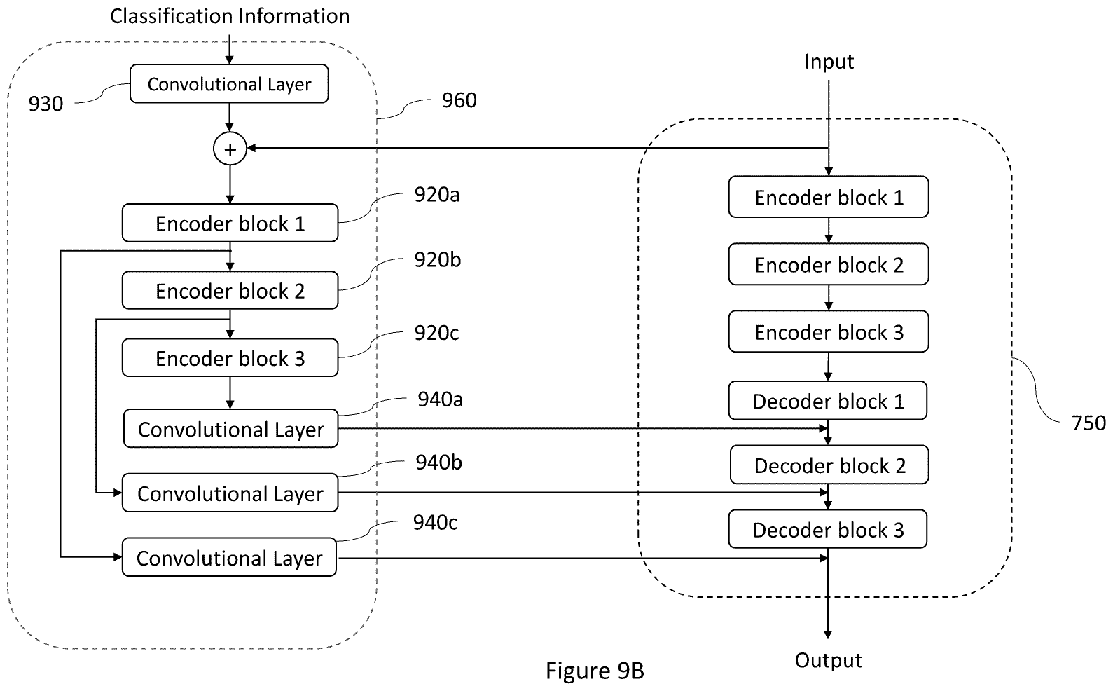

Reference is made to FIG. 9A, which illustrates part 900 of a further example image transformation model 235, which includes the denoiser network 750 and an additional part 910 for processing classification information. The diffusion network block 900 is an encoder block comprising a single convolution and pooling stage of the network 750. The image transformation model 235 also comprises a copy 920 of the diffusion network block 900. The diffusion network block 900 is trained and its model parameters locked prior to the training of the copy 920. The additional part 910 also comprises convolution layers 920, 940.

The classification information is provided as a 2D image. The convolutional layer 930 apples a 1×1 convolution to the classification information and combines the result with the input, x, to the diffusion network block 900. The result of this combination is input to the encoder copy 920, the output of which is applied to a further convolution layer 940 at which a 1×1 input is applied. The result of this further convolution layer 940 is combined with the output of a further block 950 in the denoiser network 750 to produce the output y. The further block 950 is a decoder block 950, which includes a single convolution and corresponding up sampling stage from the network 750.

Reference is made to FIG. 9B, which illustrates the denoiser network 750 and the network 960 for processing the classification information. The network 960 comprises encoder blocks 920a-c, which correspond to the encoder blocks of the denoiser network 750. However, the encoder blocks 920a-c may be trained using training data comprising classification information to have different parameters to the encoder blocks of the denoiser network 750. Each encoder block comprises a convolution stage and a corresponding downsampling stage. The network 960 comprises convolutional layers 940a-c. The convolutional layers 940a-c perform 1×1 convolutions on their inputs received from an earlier encoding block in the network 960. The output of each convolution layer 940a-c is combined with the output of a corresponding decoder block in the denoiser network 750.

The additional network 960 may be trained by applying a relatively small amount of training data, as compared to the amount of training data required to train the denoiser network 750. The training data for training the additional network 960 may comprise a set of images derived from ultrasound data (by rendering system 225) and corresponding classification information (derived by classifier 230).

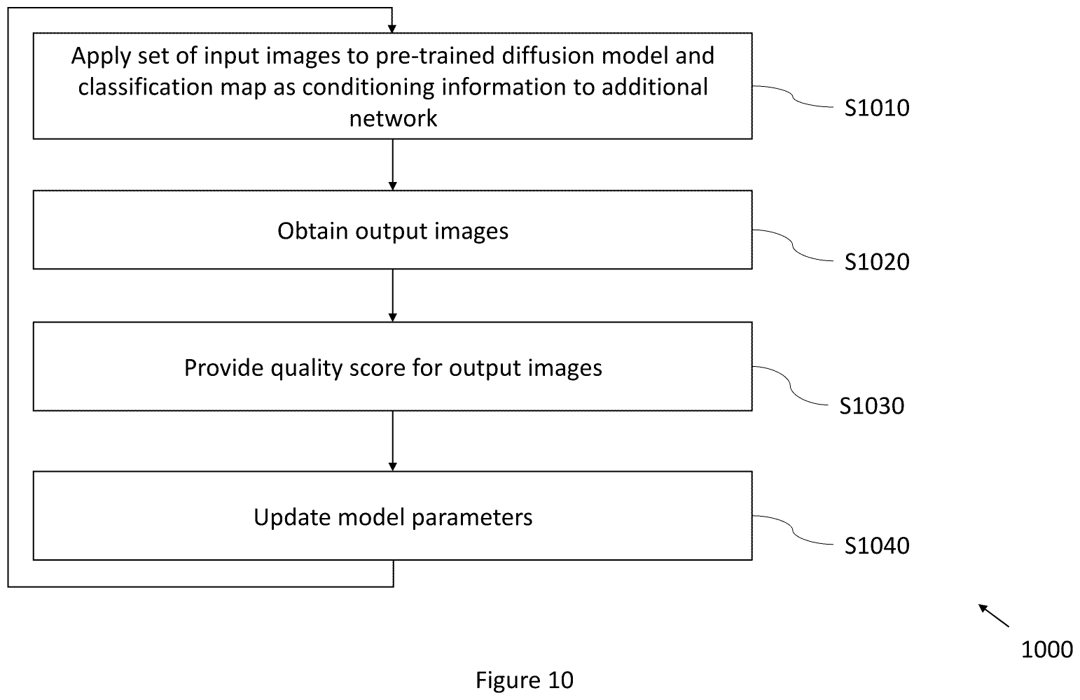

Reference is made to FIG. 10, which illustrates a process 1000 for training the additional network 960. The process may be performed by system 150 or system 160. At S1010, the images derived from the ultrasound data are applied as inputs to the pre-trained denoiser network 750, whilst the classification information (e.g. segmentation map or pose information as discussed above) is input to the additional network 960 to provide conditioning. The result of this is that at, S1020, a set of output images is obtained.

At S1030, a quality indication is provided for each image in the set of output images. This quality indication may be assigned manually by a user or by providing the images as inputs to a discriminator network. The quality indication may be a binary indication or a score on a scale of quality. At S1040, the model parameters of additional network 960 are updated based upon the quality of the images to train the network 960 to produce the higher quality images. Updating the network 960 may comprise updating the convolution filters, and/or updating weights and biases. The process 1000 the proceeds to S1010 and another training iteration is performed. During the process, the parameters of the denoiser network 750 are not updated.

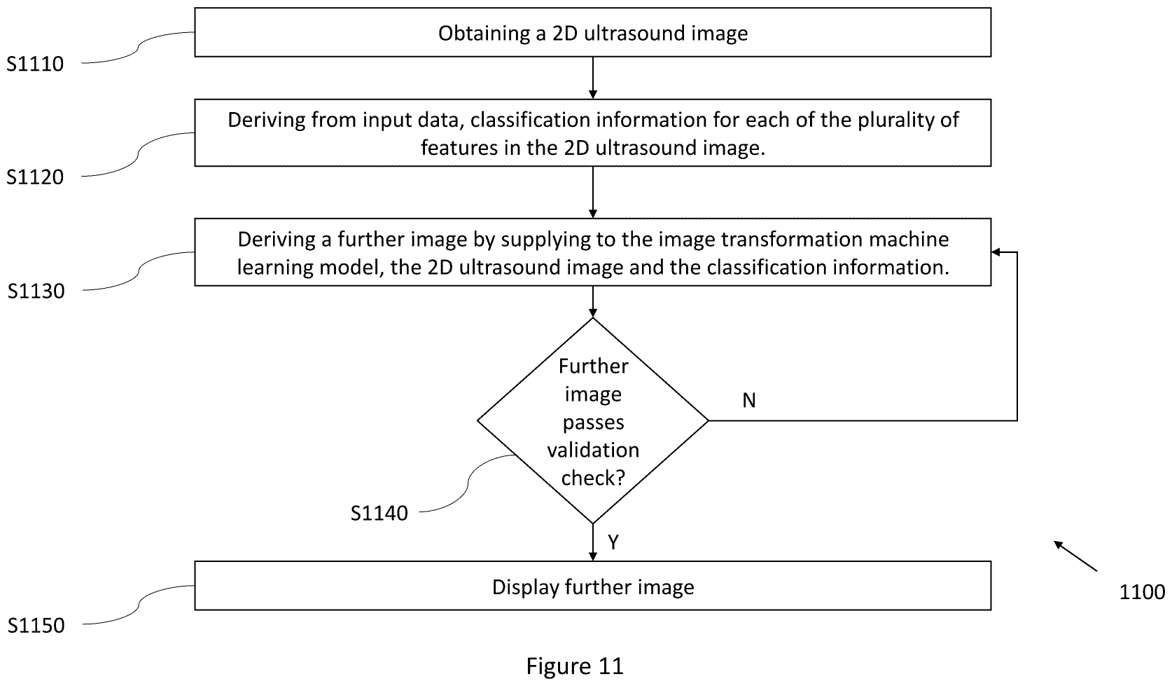

Reference is made to FIG. 11, which illustrates a computer implemented method 1100 according to embodiments. The method 1100 is implemented in a computer system (e.g. system 100, 150, 160) by at least one processor executing computer readable instructions belonging to a computer program.

At S1110, the system obtains 2D ultrasound image.

At S1120, the system derives from input data, classification information for each of a plurality of features in the 2D ultrasound image

At S1130, the system derives a rendered image by supplying the 2D ultrasound image as an input to the image transformation machine learning model. As part of deriving the rendered image, the system also supplies the classification information derived at S1120 to the image transformation machine learning model.

At S1140, the system determines whether the rendered image passes a validation check. If not, S1130 is repeated but modifying one or more parameters or inputs of the process to derive another rendered image. For example, S1130 may be repeated whilst applying a different set of noise to the 2D ultrasound image, whilst applying a different text prompt, or by using a different 2D ultrasound image rendered from the same 3D data.

If a rendered image is produced that passes the validation check at S1140, at S1150, the system causes the rendered image to be shown on a display.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

According to various embodiments there is provided, there is provided a medical Imaging Apparatus comprising an Ultrasound Scanner Capable of acquiring 3D volumes; a classifier system capable of identifying different structures within the volume (Anatomical Classifier (Eyes, mouth, nose, ears, arms, legs, torso)); a rendering system capable of transforming that 3D Image into an intermediate 2D image along with depth and object information for each pixel in the image; a diffusion-based image transformer system that takes the 2D Image, depth image and object mask image, lighting and style information and uses that to recreate a photo-realistic image of that object; and an image presentation system. In some embodiments, the apparatus comprises the addition of an image validation step and feedback loop. In some embodiments, a neural radiance field volume is generated and displayed on the scanner. In some embodiments, another 3D model representation, such as polygonal mesh, that can be rendered later is generated. In some embodiments, the diffusion-based processing happens on a remote computer. In some embodiments, the image presentation system is a separate web-based computer, where the images can be viewed at a later time. In some embodiments, a time series of volumes are used to generate a sequence of transformed images that can be viewed as an animation or movie. In some embodiments, a diffusion infill is used to fill in areas of the image where there are no identifies features.

According to various embodiments, there is provided a computer system comprising at least one processor and at least one memory comprising a set of computer readable instructions which when executed by the at least one processor cause the system to: obtain a two-dimensional ultrasound image; derive from input data, classification information for each of a plurality of features in the two-dimensional ultrasound image, the input data comprising at least one of the two-dimensional ultrasound image or three-dimensional ultrasound data corresponding to the two-dimensional ultrasound image; derive a rendered image by supplying to an image transformation machine learning model: the two-dimensional ultrasound image as an input image; and the classification information for each of a plurality of features in the input image.

According to various embodiments, the classification information comprises at least one of: a segmentation map; and pose information.

According to various embodiments, the two-dimensional ultrasound image is a first two-dimensional ultrasound image, and the rendered image is a first rendered image, wherein the computer readable instructions when executed by the at least one processor cause the system to: obtain a time series of two-dimensional ultrasound images including the first two-dimensional ultrasound image; obtain classification information for features belonging to each of the two-dimensional ultrasound images in the time series; and derive a time series of rendered images by supplying to the image transformation machine learning model, the time series of two-dimensional ultrasound images and the classification information for the features belonging to each of the two-dimensional ultrasound images in the time series, the time series of rendered images including the first rendered image.

According to various embodiments, wherein the image transformation machine learning model comprises a diffusion model.

According to various embodiments, wherein the image transformation machine learning model comprises an additional machine learning model configured to process the classification information, wherein the computer readable instructions when executed by the at least one processor cause the system to: generate by the diffusion model, the rendered image in dependence upon the result of processing the classification information by the additional machine learning model.

According to various embodiments, the diffusion model comprises a denoiser network comprising a plurality of encoders and a plurality of decoders, wherein the additional machine learning model comprises a copy of the plurality of encoders with different model parameters, wherein the step of generating the rendered image comprises: applying the outputs of the copy of the plurality of encoders to modify the outputs of the decoders.

According to various embodiments, the image transformation machine learning model comprises a generator model trained as part of a generative adversarial network.

According to various embodiments, the computer readable instructions, when executed by the at least one processor cause the system to: supply the classification information as conditioning information to the image transformation machine learning model.

According to various embodiments, the computer readable instructions, when executed by the at least one processor, cause the system to: obtain the two-dimensional ultrasound image by performing volume rendering on the three-dimensional ultrasound data.

According to various embodiments, the computer readable instructions, when executed by the at least one processor, cause the system to: obtain a depth map for the two-dimensional ultrasound image; and derive the rendered image by supplying to the image transformation machine learning model, the depth map.

According to various embodiments, the computer readable instructions, when executed by the at least one processor, cause the system to derive the rendered image by supplying to the image transformation machine learning model, a text prompt.

According to various embodiments, the computer readable instructions, when executed by the at least one processor, cause the system to: perform a validation check by supplying the rendered image to a validation machine learning model configured to output a quality indication for the rendered image; and in response to the rendered image failing the validation check, generate a third image corresponding to the three-dimensional ultrasound data by re-applying the two-dimensional ultrasound image as an input image to the image transformation machine learning model.

According to various embodiments, the image transformation machine learning model is a diffusion model configured to apply a set of noise to the two-dimensional ultrasound image to generate the rendered image, wherein the generating the third image comprises re-applying the diffusion model to the two-dimensional ultrasound image as the input image with a different set of noise applied to the two-dimensional ultrasound image.

According to various embodiments, wherein the deriving the rendered image is performed by supplying to the image transformation machine learning model, a text prompt as conditioning information, wherein the generating the third image comprises: re-applying the image transformation machine learning model to the two-dimensional ultrasound image as the input image with a different text prompt applied as conditioning information.

According to various embodiments, generating the third image comprises: generating a further two-dimensional ultrasound image by performing volume rendering on the three-dimensional ultrasound data from a different view; and deriving the third image by supplying to the image transformation machine learning model, the further two-dimensional ultrasound image as the input image.

According to various embodiments, there is provided a computer implemented method for processing ultrasound imaging data comprising: obtaining a two-dimensional ultrasound image; deriving from input data, classification information for each of a plurality of features in the two-dimensional ultrasound image, the input data comprising at least one of: the two-dimensional ultrasound image or three-dimensional ultrasound data corresponding to the two-dimensional image; deriving a rendered image by supplying to an image transformation machine learning model: the two-dimensional ultrasound image as an input image; and the classification information for each of the plurality of features.

According to various embodiments, there is provided a computer program comprising computer readable instructions, which when executed by at least one processor of a computer system cause the system to: obtain a two-dimensional ultrasound image; derive from input data, classification information for each of a plurality of features in the two-dimensional ultrasound image, the input data comprising at least one of the two-dimensional ultrasound image or three-dimensional ultrasound data corresponding to the two-dimensional ultrasound image; derive a rendered image by supplying to an image transformation machine learning model: the two-dimensional ultrasound image as an input image; and the classification information for each of the plurality of features.

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer system comprising at least one processor and at least one memory comprising a set of computer readable instructions which when executed by the at least one processor cause the system to:
obtain a two-dimensional ultrasound image;
derive from input data, classification information for each of a plurality of features in the two-dimensional ultrasound image, the input data comprising at least one of the two-dimensional ultrasound image or three-dimensional ultrasound data corresponding to the two-dimensional ultrasound image;
derive a rendered image by supplying to an image transformation machine learning model:
the two-dimensional ultrasound image as an input image; and
the classification information for each of a plurality of features in the input image.

2. A computer system as claimed in claim 1, wherein the classification information comprises at least one of:
a segmentation map; and
pose information.

3. A computer system as claimed in claim 1, wherein the two-dimensional ultrasound image is a first two-dimensional ultrasound image, and the rendered image is a first rendered image, wherein the computer readable instructions when executed by the at least one processor cause the system to:
obtain a time series of two-dimensional ultrasound images including the first two-dimensional ultrasound image;
obtain classification information for features belonging to each of the two-dimensional ultrasound images in the time series; and
derive a time series of rendered images by supplying to the image transformation machine learning model, the time series of two-dimensional ultrasound images and the classification information for the features belonging to each of the two-dimensional ultrasound images in the time series, the time series of rendered images including the first rendered image.

4. A computer system as claimed in claim 1, wherein the image transformation machine learning model comprises a diffusion model.

5. A computer system as claimed in claim 4, wherein the image transformation machine learning model comprises an additional machine learning model configured to process the classification information, wherein the computer readable instructions when executed by the at least one processor cause the system to:
generate by the diffusion model, the rendered image in dependence upon the result of processing the classification information by the additional machine learning model.

6. A computer system as claimed in claim 5, wherein the diffusion model comprises a denoiser network comprising a plurality of encoders and a plurality of decoders, wherein the additional machine learning model comprises a copy of the plurality of encoders with different model parameters, wherein the step of generating the rendered image comprises:
applying the outputs of the copy of the plurality of encoders to modify the outputs of the decoders.

7. A computer system as claimed in claim 1, wherein the image transformation machine learning model comprises a generator model trained as part of a generative adversarial network.

8. A computer system as claimed in claim 1, wherein the computer readable instructions, when executed by the at least one processor cause the system to:
supply the classification information as conditioning information to the image transformation machine learning model.

9. A computer system as claimed in claim 1, wherein the computer readable instructions, when executed by the at least one processor cause the system to:
obtain the two-dimensional ultrasound image by performing volume rendering on the three-dimensional ultrasound data.

10. A computer system as claimed in claim 1, wherein the computer readable instructions when executed by the at least one processor cause the system to:
obtain a depth map for the two-dimensional ultrasound image; and
derive the rendered image by supplying to the image transformation machine learning model, the depth map.

11. A computer system as claimed in claim 1, wherein the computer readable instructions when executed by the at least one processor cause the system to derive the rendered image by supplying to the image transformation machine learning model, a text prompt.

12. A computer system as claimed in claim 1, wherein the computer readable instructions, when executed by the at least one processor cause the system to:
perform a validation check by supplying the rendered image to a validation machine learning model configured to output a quality indication for the rendered image; and
in response to the rendered image failing the validation check, generate a third image corresponding to the three-dimensional ultrasound data by re-applying the two-dimensional ultrasound image as an input image to the image transformation machine learning model.

13. A computer system as claimed in claim 12, wherein the image transformation machine learning model is a diffusion model configured to apply a set of noise to the two-dimensional ultrasound image to generate the rendered image,
wherein the generating the third image comprises re-applying the diffusion model to the two-dimensional ultrasound image as the input image with a different set of noise applied to the two-dimensional ultrasound image.

14. A computer system as claimed in claim 12, wherein the deriving the rendered image is performed by supplying to the image transformation machine learning model, a text prompt as conditioning information, wherein the generating the third image comprises:
re-applying the image transformation machine learning model to the two-dimensional ultrasound image as the input image with a different text prompt applied as conditioning information.

15. A computer system as claimed in claim 12, wherein generating the third image comprises:
generating a further two-dimensional ultrasound image by performing volume rendering on the three-dimensional ultrasound data from a different view; and
deriving the third image by supplying to the image transformation machine learning model, the further two-dimensional ultrasound image as the input image.

16. A computer implemented method for processing ultrasound imaging data comprising:
obtaining a two-dimensional ultrasound image;
deriving from input data, classification information for each of a plurality of features in the two-dimensional ultrasound image, the input data comprising at least one of: the two-dimensional ultrasound image or three-dimensional ultrasound data corresponding to the two-dimensional image;
deriving a rendered image by supplying to an image transformation machine learning model:
the two-dimensional ultrasound image as an input image; and
the classification information for each of the plurality of features.

17. A computer program comprising computer readable instructions, which when executed by at least one processor of a computer system cause the system to:
obtain a two-dimensional ultrasound image;
derive from input data, classification information for each of a plurality of features in the two-dimensional ultrasound image, the input data comprising at least one of the two-dimensional ultrasound image or three-dimensional ultrasound data corresponding to the two-dimensional ultrasound image;
derive a rendered image by supplying to an image transformation machine learning model:
the two-dimensional ultrasound image as an input image; and
the classification information for each of the plurality of features.
